(19) United States
(12) Patent Application Publication
(10) Pub. No.: US 2014/0207389 A1
(43) Pub. Date: Jul. 24, 2014

(54) Methods for Detection and Localization of Internal and External Disturbances in a Pipeline

(71) Applicant: David Alan Hayner, Austin, TX (US)

(72) Inventor: David Alan Hayner, Austin, TX (US)

(21) Appl. No.: 13/747,988

(22) Filed: Jan. 23, 2013

(51) Int. Cl. G01M 7/00

(52) U.S. Cl. CPC G01M 7/00
USPC 702/33

(57) ABSTRACT

Apparatus and methods for the detection and localization of internal and external disturbances in and around a physical structure from data generated by an array of sensors and processing systems connected to the physical structure.

### CROSS-REFERENCE TO RELATED APPLICATIONS

### Provisional Utility Patent Application

Methods for Detection and Localization of Internal and External Disturbances in a Pipeline Application No. 61/589,906 filed Jan. 24, 2012

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field addressing applications of sensors. More specifically, this invention discloses the employment of one or more sensors, digital data processing systems and storage or communications devices to detect and determine the location of possible structural or operational failures in physical structures and potential intrusions into these structures.

Data collected by an array of sensors can be used to detect and localize the position along a pipeline that has developed a leak or other form of disruption of flow. This data can also be processed to determine if there are sources of mechanical activity in the vicinity of the pipeline, and if so, the approximate location along the pipe as well as an estimate to the orthogonal distance from the pipe to the source of mechanical disturbance. In an aircraft or sea vessel, these techniques can be employed to detect and localize eminent structural failures or other non-optimal operating conditions. As current pipeline systems age and as new pipelines are installed, there is an increasing need for continuous monitoring of activities near pipelines, such as construction activities which may potentially breach the pipeline. Further, with older pipelines, monitoring the pipelines for leaks and other types of disturbances to the flow is becoming crucial. Similar monitoring capabilities can be offered to aircraft to continuously monitor airframe dynamics to detect and/or predict the onset of potentially dangerous conditions in the airframe. Additionally, data collected by these arrays of sensor can be used to control various operations in the system to enhance the economic efficiency of the system on which this sensor network is attached. Furthermore, other desirable features and characteristics of the embodiments presented here will become apparent from the subsequent detailed description taken in conjunction with the accompanying drawings and this background.

### SUMMARY OF THE INVENTION

The present invention employs an array of sensors, microprocessors, storage media and communications systems to monitor the flow of media through or over a physical structure and detect and localize sources of structural or environmental disturbances. This invention can also be employed to detect and localize external sources of disturbance which may relate to external environmental activities which generate mechanical disturbances to the system on which the sensor array is mounted.

### BRIEF DESCRIPTION OF THE DRAWINGS

Various embodiments will hereinafter be described in conjunction with the following figures, wherein like numerals denote like elements, and

FIG. 1 is a diagram of an array of sensors and data processing system configured with a physical structure in accordance with one embodiment of the invention;

FIG. 2 is a diagram illustrating the use of a sensor array and data processing system configured with a physical structure to detect and localize external disturbances in accordance with one embodiment of the invention;

FIG. 3 illustrates a set of sample signals collected for an external disturbance as illustrated in FIG. 2 in accordance with one embodiment of the invention;

FIG. 4 is a diagram illustrating the use of a sensor array mounted on a physical structure with certain additional devices to augment the ability of the sensor array configured with the physical structure to detect and localize disturbances in accordance with one embodiment of the invention;

FIG. 5 is a diagram illustrating the use of the sensor array and data processing system to detect disturbances native, or internal, to the physical structure in accordance with one embodiment of the invention;

FIG. 6 is a diagram illustrating the use of a sensor array and data processing system to detect and localize internal or external sources of disturbances causing the propagation of mechanical waves in an arbitrarily shaped object in accordance with one embodiment of the invention;

FIG. 7 illustrates one method of time correlation processing to localize the source of a signal in an arbitrary structure in accordance with one embodiment of the invention.

### DETAILED DESCRIPTION OF EMBODIMENTS

The following detailed description is merely exemplary in nature and is not intended to limit the scope or the application and uses of the described embodiments. Furthermore, there is no intention to be bound by any theory presented in the preceding background or the following detailed description.

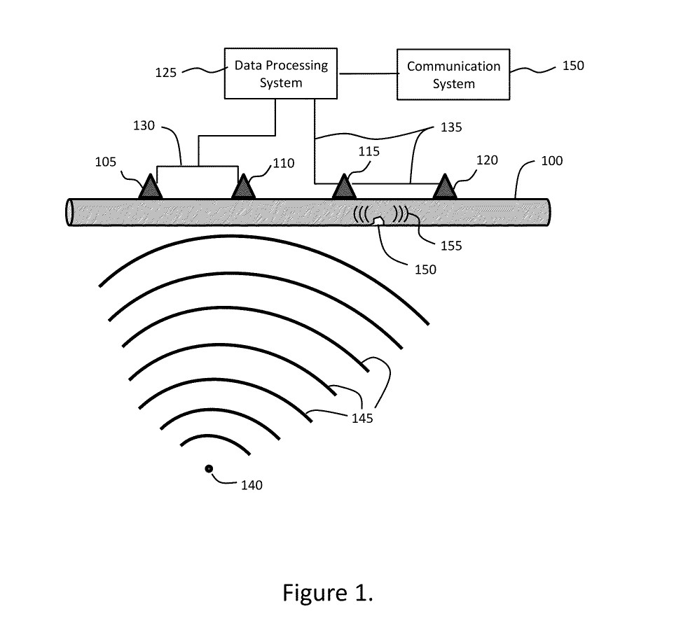

Referring now to the invention, FIG. 1 illustrates multiple sensors, 105, 110, 115 and 120 mechanically attached to a section of pipeline 100. Sensors 105 and 110 are connected to the data processing system 125 via communications bus 130. Sensors 115 and 120 are connected to the data processing system 125 via an alternate communications bus structure 135. The point of the two alternate communications bus structures is that this invention is substantially independent of the means by which data collected by sensors 105, 110, 115 and 120 are transferred to the data processing system 125. Also illustrated in FIG. 1 is a source of external (to this section of pipeline) mechanical disturbance, 140. The mechanical waves generated by this disturbance in the surrounding media (earth, water, air or combination of these) are illustrated with lines 145. The source of these external disturbances may, for example, be construction or manufacturing activities, transportation activity, earth or weather processes (earthquakes or ocean waves, avalanches, rock falls, etc.). Mechanical disturbance signals 145 are coupled to the pipeline via the surrounding media and propagate through the pipeline to the sensors 105, 110, 115 and 120 where these mechanical waves are measured and converted to electrical signals. Some aspect of these external mechanical disturbances may be directly coupled to, and measured by the sensors 105, 110, 115 and 120. Also illustrated in FIG. 1 is an internal source of mechanical disturbance, 150. This may be a leak, a break, an internal obstruction, void or other physical structure that generates mechanical vibrations as a result of material flow in the pipeline or reflections of mechanical signals propagating in the pipeline. This internal source 150 may also be mechanical system attached to the pipeline such as a pump.

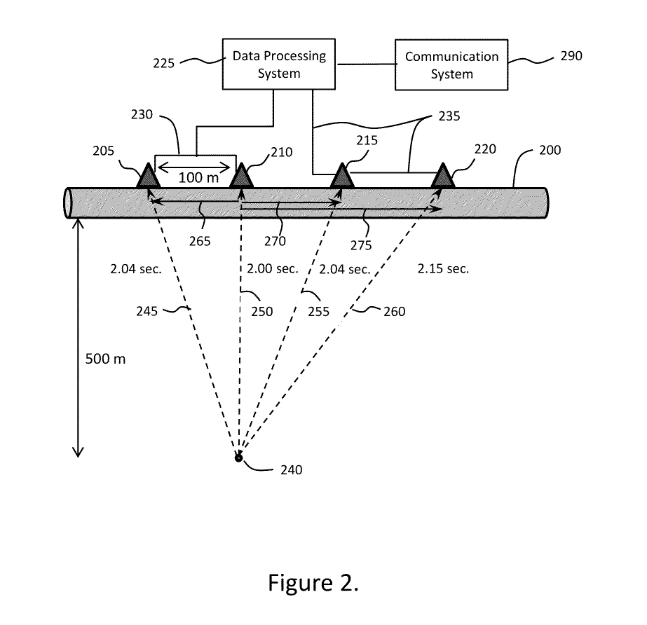

More generally, the physical structure 100 in FIG. 2 can be any of a wide variety of physical structures such as an airframe, hull of a ship, truck, construction equipment, bridge, road or building to list a few. The exemplary discussion in this document will focus on pipelines for the sake of clarity. The techniques described are applicable to a much wider class of physical structure. Material flow may be water around the hull of a ship or bridge, airflow around the airframe of an aircraft or building, oil or water flow in a pipeline to name a few. Flow of the material on, around or within these physical structures will generally generate flow structures, which in-turn, generate or induce mechanical vibrations into the physical structure on which these sensors are mounted. Changes in this flow due to changes in the physical structure to which the sensors are mounted generally induce a change in the vibratory nature of the mechanical vibrations induced into the physical structure.

Referring again to FIG. 1, the mechanical signal detected by the array of sensors 105, 110, 115 and 120 are converted to electrical signals and communicated by either communications connection 130 or communications system 135 to the data processing system 125. Data processing system 125 can either store this data for later processing, forward the data via communications systems 150 to other devices, process this data or any combination of these operations. In general, data processing system 125 will implement various signal analysis methods such as filtering and spectral processing to detect and classify various types of signals. This processing may also include signal processing techniques such as bandpass, lowpass, highpass filtering to extract or segregate various components of these signals for further analysis. Time correlation processing may also be performed in the data processing system 125 in order to localize the source of signal internal or external disturbance. Data processing system 125 may forward these results or subsets of these results to other data collection and analysis systems (not illustrated) via communication systems 150.

Illustrated in FIG. 2 is a representative example of the signals collected by this sensor array. External disturbance 240 generates vibrations which travel through the earth, air, water, combination of all these or other mediums surrounding the pipeline and are coupled, in various ways, to the pipeline 200. These coupled mechanical vibrations then propagate along the pipeline 200. For a representative impulse signal at external source 240, each of the sensors 205, 210, 215 and 220 receive two or more signals. One of these signals is the line-of-sight signal indicated by dashed lines 245, 250, 255 and 260. The second is a signal due to the mechanical signals coupling to the pipeline 200 and then propagating along the pipeline 200. In this second case, these two paths combine for a effective path length equal to the distance traveled through the intervening surrounding media (soil in this example) divided by the propagation speed through this media plus the distance traveled through the pipeline 200 divided by the propagation speed in this media. For this example, a propagation speed of 250 meters/sec. is assumed for the media surrounding the pipeline 200 and a propagation speed of 5000 meters/sec. is assumed for the mechanical waves propagating in the steel pipeline.

For the four sensors 205, 210, 215 and 220 illustrated in FIG. 2, the path lengths are calculated as follows. For sensor 205, the effective path length is a combination of the path along the line 250 through the surrounding media, approximately 500 meters at 250 meters/sec., plus distance 265 through the pipe 200, 100 meters at 5000 meters/sec. for a total time of approximately 2.02 sec. The direct line-of-sight path length is along path 245 approximately 510 meters at 250 meters/sec. for a total line-of-sight path time of 2.04 sec. In this specific example, as a result of symmetric position of sensor 215 relative to 205 and the source of disturbance 240, the direct line-of-sight and combination effective path lengths are the same as for sensor 205. For sensor 210, the effective path length is 250 through the soil, approximately 500 meters at 250 meters/sec. resulting in a signal detected by sensor 210 approximately 2.00 seconds after the event. The path length through the pipe is negligible for in this example for sensor 210. For sensor 220, the direct line-of-sight path length, 260 is approximately 539 meters at 250 meters/sec. for a direct line-of-sight path time of approximately 2.15 sec. The combined path length for sensor 220 is line 250 through the soil, approximately 500 meters at 250 meters/sec. plus distance 275 through the pipe, 200 meters at 5000 meters/sec. for a total combined time of 2.04 sec.

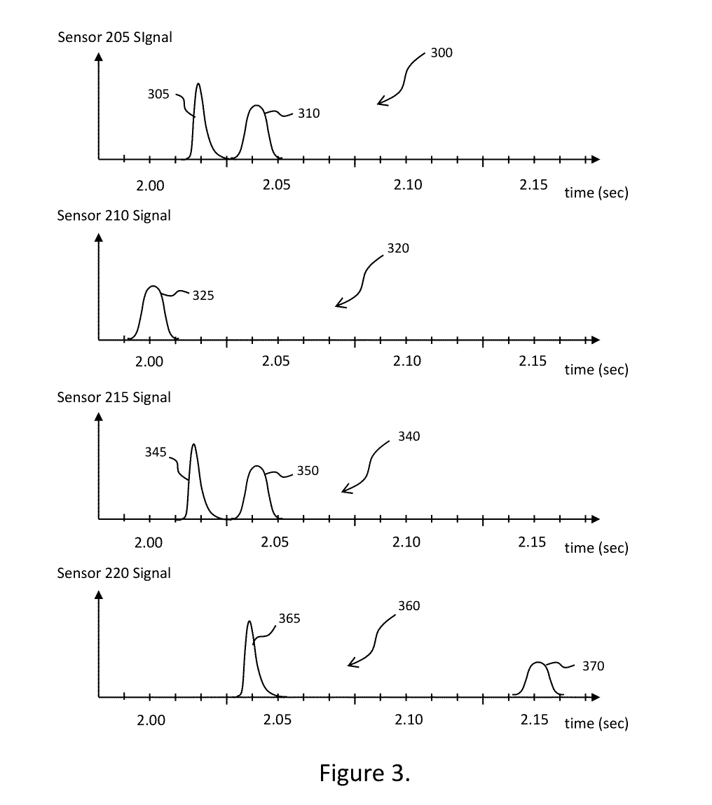

Time versus signal plot representations of these various signals are illustrated in FIG. 3. Plot 300 represents signals associated with sensor 205 of FIG. 2. The direct line-of-sight signal is represented by pulse 310 and the combined path length signal is represented by signal pulse 305. Sensor 210 signal is illustrated in plot 320 as pulse 325 arriving at 2.02 sec. Due to the aforementioned symmetry, sensor 215 signals illustrated in plot 340 are substantially the same as sensor 205 signals with the direct-line-of-sight signal represented as pulse 350 and the combined transport signal represented as pulse 345. Sensor 220 signals are illustrated in plot 360 with the direct-line-of-sight signal as pulse 370 and the combined transport pulse 365.

In determining the approximate location of the external source of disturbance, differences in arrival time of the pulses and differences in pulse shape (spectral content) are the basic techniques employed in this invention. The spectral characteristics and consequently the temporal characteristics of the signals associated with substantially direct line-of-sight measurement of external signals will generally be distinct from the temporal characteristics of signals traveling in the pipe. One reason for this difference is the dispersive characteristics of a metal pipe vs. the dispersive characteristics of surrounding material such as soil, rock, sand, water and various combinations of these materials. Analysis of the spectral/temporal characteristics of these signals will aid in the classification and detection of disturbances. Analysis of the time correlation of the various signals will enable the estimation of the spatial source of the disturbances.

In the example illustrated in FIG. 2 and FIG. 3, the substantially identical arrival times for the mechanical waves propagating in the pipe and direct line-of-sight indicates that the source must be approximately equidistant from sensors 205 and 215. This implies that the source must be perpendicular to a point on the pipe approximately equidistant from sensors 205 and 215. The substantial lack of a pipeline propagating signal at sensor 210, which is equidistant to sensors 205 and 210 supports this assessment. This is represented in time versus signal plot 320 in FIG. 3. This assessment is further supported by the timing and correlation of pulse 365 from sensor 220 relative to signals from sensors 205, 210 and 215. With knowledge of the approximate point along the pipe to which the source is perpendicular, the direct-line-of-sight signals can be employed both to support (or refute) this assessment and determine the approximate distance from the pipe.

Continuing with the analysis of the example illustrated in FIG. 2 and FIG. 3, time correlation of direct line-of-sight signals received by sensors 205 and 215, signals 310 and 350 respectively support the determination of the perpendicular point (along the pipe) and can also be used to estimate the perpendicular distance between pipeline 200 and disturbance source 240. Triangulation techniques employing the known arrival time differences between pulse 310 from sensor 205 and pulse 350 from sensor 215 relative to pulse 325 from sensor 210 can provide an estimate for the perpendicular distance from the pipe to the source. This estimate can be further supported by use of time differences between signal 370 from sensor 220 and pulse 325 from sensor 210. Given the knowledge of the pipeline's location and the positions of sensors 205, 210, 215 and 220 along the pipeline, an approximation can then be made the location of the external disturbance source 240.

As can be readily seen from this simple example, there is an ambiguity in the direction from the pipeline 200 to the disturbance source 240. The methods just described can generate an estimate of the source of the external disturbance to an arc of a specific radius, centered on the pipeline 200 and perpendicular to a specific location along the pipeline 200. In many cases, this degree of uncertainty may not be acceptable. In regions where the pipeline 200 deviates substantially from approximately a straight line, there will be cases where the angle subtended of this arc of ambiguity is reduced by the asymmetry of the pipeline and attached sensors relative to the local region. Further, specific characteristics concerning how the pipeline is constructed and local geography will also limit certain ambiguities in location of the external disturbance source.

Effectively, the pipeline is acting as a large antenna, providing a large surface area for the collection of external disturbance energy, e.g., the mechanical waves propagating through the media surrounding the pipeline. This energy couples into the pipeline and then the pipeline provides a transport media to carry this energy to the sensors attached to the pipeline. Expanding this view of the pipeline as a receiving antenna, this antenna can be augmented with various internal and external structures to enhance performance and/or provide additional capabilities.

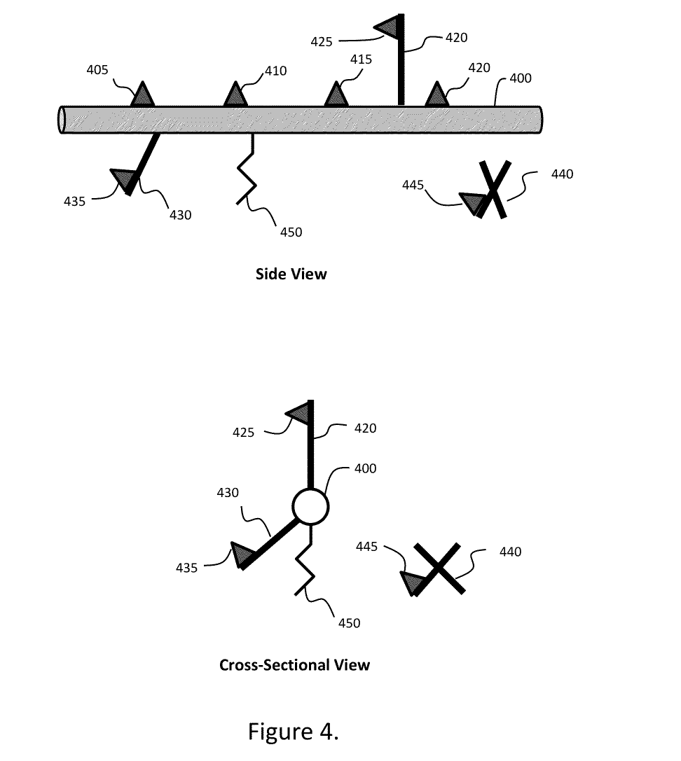

In some cases, the pipeline may be augmented with devices to introduce an intentional asymmetry in the location of sensors and/or in the locations at which mechanical waves propagating in the media surrounding the pipeline are coupled into the pipeline. Some representative examples are illustrated in FIG. 4. Sensors 405, 410, 415 and 420 are similar to the sensors in examples in FIG. 1 and FIG. 2 and provide similar functions. Sensors 405, 410, 415 and 420 are connected to a data processing and communications systems as illustrated in FIGS. 1 and 2. Asymmetry which is useful in the localization of external (and internal) disturbances can be enhanced by the addition of physical structures 420 and 430 attached to pipeline 400 with sensors 425 and 430 respectively. These sorts of structures may be intentionally placed along the pipeline 400 at specified intervals in order to provide non-symmetrical sensing locations to eliminate ambiguity in localizing external and internal disturbances. These structures may be oriented in various ways and used in combinations. It is also possible that these extra sensor structures may be placed external to the pipeline as illustrated with mechanical structure 440 and sensor 445. Sensor 445 is still electrically connected to a data processing system via some bus or connection system not illustrated in FIG. 4.

These augmentation structures may also be intended to improve the impedance match between the media surrounding the pipeline and the pipeline to improve the coupling of external disturbance energy into the pipeline 400 for measurement by the sensors 405, 410, 415, 420, 425 and 435. A representative example of one such structure is 450 in FIG. 4.

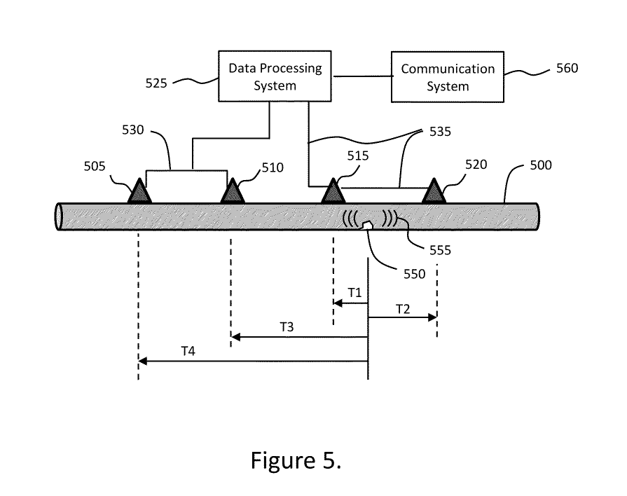

In the measurement, detection and localization of internal disturbances, changes in signal amplitude and timing as a function of position as well as the dispersive characteristics of the signal spectrum in the structure are employed for the detection and classification of the types of disturbance as well as localization. Illustrated in FIG. 5 is a representative pipeline structure with 4 sensors 505, 510, 515 and 520 physically attached to pipeline 500. These sensors are connected to the Data Processing System 525 by various bus systems 530 and 535. Communications System 560 provides a means for data processing system 525 to forward data and results to external systems, receive updates or commands and in general interact with other systems. An internal disturbance, 550 generates a mechanical wave 555 propagating in the pipeline structure. Material (oil, water, etc.) flowing in the pipeline, when encountering a crack, hole or other discontinuity in the pipeline will, in general, generate flow disturbance signals. Typically, these signals are substantially periodic and thus, the mechanical waves propagating in the pipe and detected by the sensors are substantially periodic.

However, flow of material in a pipeline is not perfectly uniform. There are short term variations in density, temperature, pressure, etc. in this flow as a function of time. As these variations in material flow encounter a discontinuity in the pipeline, there are a transient changes in the disturbance signals generated. The propagation of these changes in the disturbance signal along the pipeline and time correlation of these changes enable the localization of the source of these signals, and consequently, the location of the disturbance internal to the pipeline. Illustrated in FIG. 5 are 4 time intervals T1, T2, R3 and T4. These represent the time differentials of detecting a change in the disturbance waveform structure propagating along the pipeline and illustrate the ability to localize the source of disturbance via analysis of these time correlations. Changes over time in stresses in the pipeline can also cause changes in the characteristics of the propagating internal (and external) disturbances.

Analysis of the characteristics of the internally generated signals and the transient changes in these signals can be employed to detect and characterize various types of internal sources or disturbances. Results of this analysis can be employed to trigger more detailed analysis of data, forward warnings to external systems via the communications system 560 and provide automatic compensation techniques for ameliorating the impact of these internal disturbances on the integrity of the pipeline or in the flow of material through the pipeline.

In the pipeline example discussed and illustrated in FIG. 2 and FIG. 3, many assumptions have been assumed in order to aid in the description of the methods. In many cases, the material surrounding a pipeline is not uniform and the properties of this material can change in time (with weather and other effects) and with location. This will impact the speed and attenuations of signals propagating through the material surrounding the pipeline. Further, changes in the surrounding material can also introduce reflections, multi-path and any number of other complicating phenomena. In many cases, these local material changes can be mapped out and accommodations can be made in the signal processing methods employed. These effects do not substantially impact the basic concepts taught in this disclosure.

Basic time correlation methods have been employed to illustrate the fundamental concepts of this patent disclosure. Significantly more sophisticated methods can be employed for the analysis of the sensor data for detection, classification and localization and as understood by those skilled in the appropriate arts. The techniques of SONAR for example.

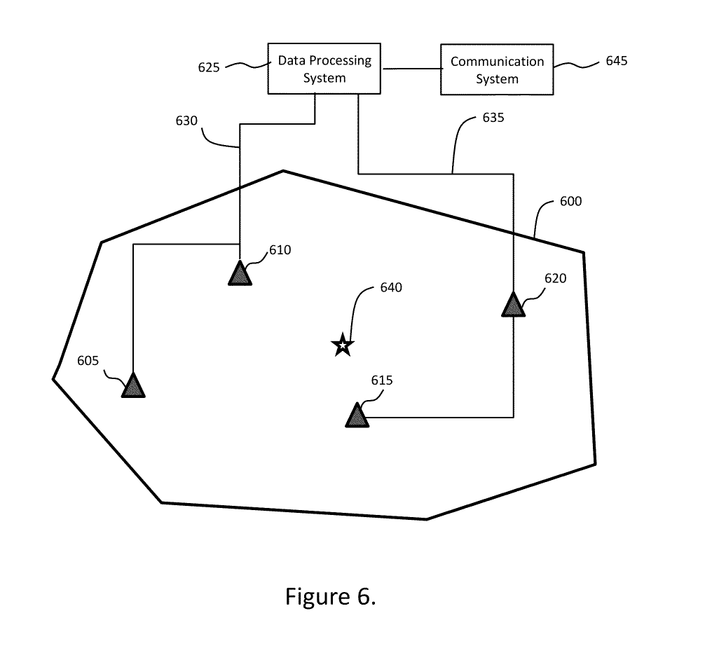

Illustrated in FIG. 6 is a more general physical structure with four sensors 605, 610, 615 and 620 attached to physical structure 600. These four sensors are connected to a Data Processing System 625 via communications bus 630 or communications bus 635. Data Processing System 625 is connected to Communications System 645 providing a means for data processing system 625 to forward data and results to external systems, receive updates or commands and in general interact with other systems. The physical structure 600 illustrated as two-dimensional plate can be an arbitrary two or three dimensional structure. Also illustrated is a hypothetical internal source of a signal, 640. This source may be due to fluid flow over the structure, this flow disturbed, or disturbing some local non-uniformity in the structure; it may be due to some sympathetic vibration due to other energy input to the structure 600; it may be due to a device, a motor for instance, attached to structure 600 generating a signal. In all cases, these signals become mechanical waves propagating in the structure and can be measured by the various sensors 605, 610, 615, and 620.

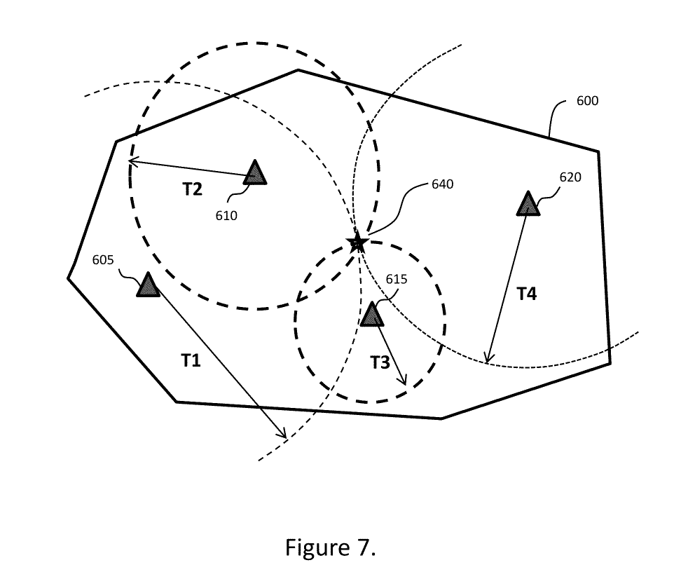

Signals detected by this array of sensors 605, 610, 615 and 620 are converted to electrical signals and communicated by either communications system 630 or communications system 635 to the data processing system 625. Data Processing System 625 can either store this data for later processing, forward the data via communications system 645 to other devices, process this data or any combination of these operations. In general, this processing will implement various time correlation processes in order to localize the source of signal. Other processing activities may include methods to characterize or classify the signals received, filter or extract various subsets of data from the signals received. Illustrated in FIG. 7 is a simplified example of employing time correlation to localize the source of the signal. Time differences for each of the four sensors can be generated. These are illustrated as T1 for sensor 605, T2 for sensor 610, T3 for sensor 615 and T4 for sensor 620. The mutual intersection of these time differences, illustrated as circles or arcs in FIG. 7, specify the location of the source, 640.

The sensors employed in this invention may consist of accelerometers, gyroscopes, pressure, acoustic, temperature, magnetic, optical, torsion, tension, force or other such measures of motion or applied forces and deformation. Magnetometers may also be used as sensors in which they detect a change in the local magnetic field structure as a result of construction equipment, vehicles or other metal or current carrying systems nearing the pipeline. These sensors may be arranged in any number of combinations, structures and relationships and with varying quantities of sensors. The communications systems may be any of a number of methods currently available or that may become available in the future. The methods taught in this patent are substantially independent of the bus, communications, sensor type, number, arrangement and organization.

These disclosed detection and localization processes can be implemented either in a centralized top-down approach, in a de-centralized approach or in some combination. In many cases, it is anticipated that a local data processing system would be dedicated to some defined set of sensors over some length of pipeline or over some area of the structure. This local data processing system would manage the sensors and processing over some subset of sensors. Specific implementation details are strongly related to the details of the relevant communications structure. The detection and localization processes taught in this invention are substantially independent of the communications infrastructure.

The previous discussion is not intended to limit the specific numbers, types and arrangements of sensors. References to specific techniques are used only as a means to explain an example of the art. Those skilled in these methods are aware of many alternate methods that can be employed.

In summary, systems, devices, and methods configured in accordance with exemplary embodiments relate to:

Physical structures augmented with several sensors coupled in some communications network to a data processing system in which the known configuration of the physical structure and associated sensor array allows for the detection, classification and localization of both internal and external sources of disturbances by various processing methods implemented in the data processing system. In certain embodiments, the sensors may be one or more of an accelerometer, gyroscope, pressure, acoustic, temperature, magnetic, optical, torsion, tension or force measuring devices.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention.

What is claimed is:

1. A data acquisition and processing system integrated into a transportation bridge structure comprising:
at least two sensors networked together in a manner enabling a digital processing system to acquire data generated by the sensors and communicate results of processing this data to remote systems;
said sensors are one of an accelerometer, gyroscope, pressure, acoustic, temperature, magnetic, optical, torsion, tension and force measuring devices;
said sensors are physically distributed on said transportation bridge structure in such a manner that said sensors sample propagating mechanical waves in said transportation bridge structure and sample external mechanical waves as they impact and interact with said transportation bridge structure;
digital processing methods to estimate the location of an internal source of mechanical disturbance in said transportation bridge structure; and
digital processing methods to estimate a set of potential locations of an external source of mechanical disturbance effecting said transportation bridge structure.

2. The data acquisition and processing system integrated into a transportation bridge structure as described in claim 1 further comprising a second physical structure mechanically attached to said transportation bridge structure, this second physical structure contains additional sensors attached to this second physical structure and connected to said data processing system, this second physical structure positioning additional sensors in manners introducing asymmetries into the positions of the combination of sensors attached to said transportation bridge structure and sensors attached to this second physical structure.

3. The data acquisition and processing system integrated into a transportation bridge structure as described in claim 1 further comprising a second physical structure physically separated from said transportation bridge structure, this second physical structure containing additional sensors attached to this second physical structure and connected to said data processing system, this second physical structure locating these additional sensors in manners introducing asymmetries into the positions of the combination of sensors attached to said transportation bridge structure and sensors attached to this second physical structure.

4. The data acquisition and processing system integrated into a transportation bridge structure as described in claim 1 further comprising a second physical structure mechanically coupled to said transportation bridge structure, this second physical structure providing specific localized improvements in the impedance match between media surrounding said transportation bridge structure and said transportation bridge structure, said improvements in impedance match improving the transmission of external disturbance signals into said transportation bridge structure.

5. A data acquisition and processing system integrated into a pipeline transportation structure comprising:
at least two sensors networked together in a manner enabling a digital processing system to acquire data generated by the sensors and communicate results of processing this data to remote systems;
said sensors are one of an accelerometer, gyroscope, pressure, acoustic, temperature, magnetic, optical, torsion, tension and force measuring devices;
said sensors are physically distributed on said pipeline transportation structure in such a manner that said sensors sample propagating mechanical waves in said pipeline transportation structure and sample external mechanical waves as they impact and interact with said pipeline transportation structure;
digital processing methods to estimate the location of an internal source of mechanical disturbance in said pipeline transportation structure; and
digital processing methods to estimate a set of potential locations of an external source of mechanical disturbance effecting said pipeline transportation structure.

6. The data acquisition and processing system integrated into a pipeline transportation structure as described in claim 5 further comprising a second physical structure mechanically attached to said pipeline transportation structure, this second physical structure contains additional sensors attached to this second physical structure and connected to said data processing system, this second physical structure positioning additional sensors in manners introducing asymmetries into the positions of the combination of sensors attached to said pipeline transportation structure and sensors attached to this second physical structure.

7. The data acquisition and processing system integrated into a pipeline transportation structure as described in claim 5 further comprising a second physical structure physically separated from said pipeline transportation structure, this second physical structure containing additional sensors attached to this second physical structure and connected to said data processing system, this second physical structure locating these additional sensors in manners introducing asymmetries into the positions of the combination of sensors attached to said pipeline transportation structure and sensors attached to this second physical structure.

8. The data acquisition and processing system integrated into a pipeline transportation structure as described in claim 5 further comprising a second physical structure mechanically coupled to said transportation bridge structure, this second physical structure providing specific localized improvements in the impedance match between media surrounding said transportation bridge structure and said transportation bridge structure, said improvements in impedance match improving the transmission of external disturbance signals into said transportation bridge structure.

9. A data acquisition and processing system integrated into a transportation vehicle structure comprising:
at least two sensors networked together in a manner enabling a digital processing system to acquire data generated by the sensors and communicate results of processing this data to remote systems;
said sensors are one of an accelerometer, gyroscope, pressure, acoustic, temperature, magnetic, optical, torsion, tension and force measuring devices;
said sensors are physically distributed on said transportation vehicle structure in such a manner that said sensors sample propagating mechanical waves in said transportation vehicle structure and sample external mechanical waves as they impact and interact with said transportation vehicle structure;
digital processing methods to estimate the location of an internal source of mechanical disturbance in said transportation vehicle structure; and
digital processing methods to estimate a set of potential locations of an external source of mechanical disturbance effecting said transportation vehicle structure.

10. The data acquisition and processing system integrated with a transportation vehicle structure as described in claim 9 in which this transportation vehicle is a vessel designed for transport in water.

11. The data acquisition and processing system integrated with a transportation vehicle structure as described in claim 9 in which this transportation vehicle is a vessel designed for airborne transport.

12. The data acquisition and processing system integrated with a transportation vehicle structure as described in claim 9 in which this transportation vehicle is designed for ground transport.
